(19) United States
(12) Patent Application Publication
(10) Pub. No.: US 2011/0086270 A1
(43) Pub. Date: Apr. 14, 2011

(54) MESOPOROUS PARTICULATE MATERIALS

(75) Inventors: Katherine Elizabeth Amos, Eastleigh (GB); Tobias James Gordon-Smith, Eastleigh (GB); Alan Daniel Spong, Hedge End (GB)

(73) Assignee: Nanotecture Ltd

(21) Appl. No.: 12/920,048

(22) PCT Filed: Feb. 27, 2009
(86) PCT No.: PCT/GB09/00545

§ 371 Date: Dec. 23, 2010

(30) Foreign Application Priority Data
Feb. 29, 2008 (GB) 0803870.5

(51) Int. Cl. H01M 4/04; H01M 4/36; C25C 7/02; H01B 1/00; B05D 7/00

(52) U.S. Cl. 429/219; 429/220; 429/221; 429/222; 429/224; 429/229; 429/231; 428/402; 204/280; 427/212; 29/623.1

(57) ABSTRACT

Relatively disordered mesoporous particulate materials have internal porosity, a surface area of 100 m2/g or greater with a network of pores characterised by a peak in the pore size distribution at a value between 2 and 20 nm and a ratio of the half-height width of the distribution's peak to the pore diameter axis position of the peak of at least 0.6.

The present invention relates to a mesoporous particulate material having a higher degree of disorder than has been seen hitherto in such materials.

In recent years, much attention has been focussed on nano-scale materials, many of which have properties significantly different from the same materials on a larger scale. Amongst the considerable body of work on this subject, one strand has examined the utility of nanoporous or mesoporous materials prepared by deposition from a liquid crystal phase.

For example EP 0993512 (U.S. Pat. No. 6,503,382) describes the preparation of mesoporous (“nanoporous”) metals having an ordered array of pores by electrodeposition from an essentially homogeneous lyotropic liquid crystalline phase formed from a mixture of water and a structure directing agent. The resulting films of mesoporous metals are said to have many uses, including in electrochemical cells.

EP963266 (U.S. Pat. No. 6,203,925) describes a similar process except that the metal is formed by chemical reduction.

EP 1570534 and EP 1570535 describe the use of these and other mesoporous materials, including the metal oxides and hydroxides, in electrodes and in electrochemical cells and devices containing them.

EP 1741153 describes an electrochemical cell containing titanium dioxide and/or a lithium titanate, which may be mesoporous, as the negative electrode in a cell containing lithium and hydroxide ions.

Mesoporous materials of the type the subject of the present invention are sometimes referred to as “nanoporous”, as they are, for example, in EP 0993512. However, since the prefix “nano” strictly means 10⁻⁹, and the pores in such materials may range in size from 10⁻⁸ to 10⁻⁹ m, it is better to refer to them, as we do here, as “mesoporous”. However, the term “nanoparticle”, meaning a particle having a particle size of generally nanometre dimensions, is in such widespread use that it is used here, despite its inexactitude.

In the past, it has been considered that the benefits of the mesoporous materials require a high degree of order in its porosity, and the reader, for example, of the documents referred to above will find considerable emphasis is placed on achieving a highly ordered array of pores.

We have now surprisingly discovered that this high degree of order is not necessarily required and that a certain degree of disorder can be permitted while still achieving the benefits of the mesoporous structure. This is particularly surprising in the case of materials used as electrodes in electrochemical cells, as it had always been thought that the high degree of order contributed to the useful properties of the electrodes. The use of relatively disordered materials has the important commercial advantage that the cost of manufacture is significantly lower than for relatively more highly ordered materials.

Thus, the present invention consists in a mesoporous particulate material having internal porosity, a surface area, in the case of a metal, of at least 30 m²/g or, in other cases, of at least 100 m²/g with a network of pores characterised by a peak in the BJH pore size distribution in the range from 2 to 20 nm and a disorder ratio, as defined, of at least 0.6.

Mesoporous particulate material is defined herein as material in particle form in which the particles have internal porosity of at least 15% characterised in that most of their surface area (i.e. at least 50%, more preferably at least 75%, most preferably at least 90%) is due to the presence of pores in the meso-range (i.e. 10⁻⁸ to 10⁻⁹ m). This distinguishes the materials of the present invention from “microporous materials” which also have high surface areas and may have some porosity in the meso-range but which have a substantial amount (i.e. at least 50%, more commonly at least 75%, most commonly at least 90%) of their surface area due to porosity in the range below 2 nm.

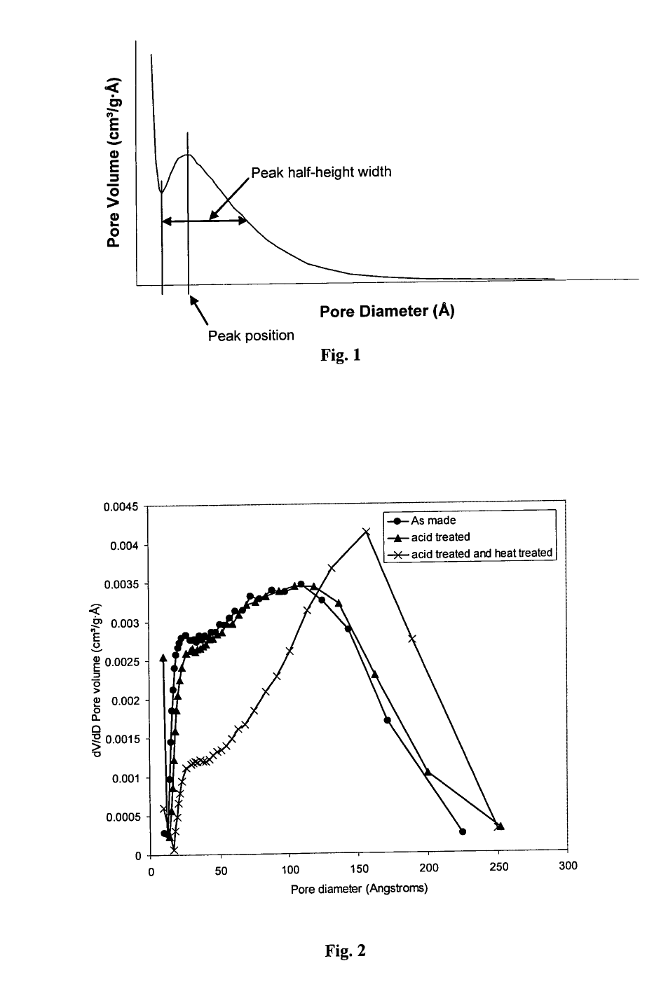

The disorder ratio is the ratio of the peak half height width of the peak, or the highest peak, within the range of pore sizes from 2 to 20 nm, divided by the pore diameter at that peak, on a graph of pore volume (expressed as cm³/g.Å) against pore diameter (expressed as Å). This is illustrated in FIG. 1 of the accompanying drawings.

The extent of disorder in the porosity of the present invention is described herein using data contained within the BJH pore size distribution measured using the nitrogen porosimetry technique. More specifically, the ratio of the half-height width of the distribution's peak to the pore diameter axis position of the peak is used. Where more than one peak is observed in the pore size distribution the highest peak is used. This disorder ratio is at least 0.6, preferably from 0.6 to 12, more preferably from 0.6 to 5, and most preferably from 0.7 to 3.

This method of measuring disorder provides a simple quantification of the spread in pore diameters in a material sample while considering this with respect to the average pore diameter of the material. Most simply, the ratio increases as the spread in pore diameter increases, reflecting an increase in the extent of disorder.

It is well known that the BJH model for determining pore size distribution becomes inaccurate when used to interrogate pore sizes below the meso-range, that is, pores with diameters smaller than approximately 2 nm. This is seen practically in pore size distribution plots with a rapidly rising part of the curve at pore diameters generally between 1 and 2 nm as seen for example in FIG. 1 of the accompanying drawings. In such cases, where the curve does not fall to the half-height level on the small pore diameter side of the peak, the small pore diameter figure used to determine peak half-height width should be taken as the pore diameter corresponding to the lowest point (by pore volume) below the peak, as shown in FIG. 1. The term “peak position” refers to the pore diameter corresponding to the peak of the pore size distribution.

Surface area and pore size distribution, as defined herein, have been measured using nitrogen porosimetry analysis. In the case of surface area determination, this involves adsorption and desorption of a monolayer of nitrogen molecules on the surface of the material, and using the quantity of gas adsorbed in a calculation developed by Brunauer, Emmet and Teller to determine surface area. This method is thus known as the BET method. Pore size distribution is determined using an extended version of this method in which the nitrogen gas is allowed to fill the pores of a material (as opposed to creating a monolayer coverage). Measurement of the amount of gas required to fill the pores and the pressure at which pore filling occurs allows calculation of the pore size distribution of the material using a theory developed by Barrett, Joyner and Halenda. This is known as the BJH method. Adsorption isotherms rather than desorption isotherms were used to calculate the pore size distribution figures quoted and claimed herein. These methods are well known to those skilled in the art.

In a further aspect, the present invention provides a process for the preparation of a mesoporous particulate material formed of a first compound or an element, which process comprises forming a mixture comprising a second compound from which the first compound or element may be deposited, a solvent and a surfactant in amounts sufficient to form a liquid crystal phase in the mixture; and depositing the first compound or the element from the second compound, under conditions of concentration, reaction time and reaction temperature such as to form a particulate material wherein particles have internal porosity characterised by a disordered pore structure, a surface area of 30 or 100 m²/g or greater with a network of pores characterised by a peak in the pore size distribution between 2 and 20 nm and a disorder ratio of at least 0.6.

A number of synthetic routes involving the use of liquid crystal templates to form mesoporous materials has been developed. U.S. Pat. No. 5,098,684 and U.S. Pat. No. 5,102,643 describe the preparation of mesoporous silica and aluminosilicate materials using liquid crystal templates formed from ionic surfactants. The mesoporous materials formed had well controlled pore diameters that were adjustable in the range 1.3 nm to 10 nm. Taney and Pinnavaia (Nature, Vol. 267, p. 865, 1995) described a method for making relatively well ordered mesoporous materials using non-ionic surfactants as the basis of a liquid crystal template. All of the above methods produced materials with ordered mesopore structures as characterised by the presence of at least one strong peak in small angle x-ray scattering data corresponding to a lattice spacing in the range 1 nm to 10 nm. The synthesis methods described in the above documents rely on interaction between the surfactant species and the precursor of the inorganic species deposited in order to form the liquid crystal template. Such interactions may include strong electrostatic interactions and ion pairing where ionic surfactant-based templates are used or complexation and/or hydrogen bonding in cases where non-ionic surfactants are the basis of the template. Further, such synthesis routes tend to use amounts of surfactant in the range 5% to 25%. The use of such low surfactant concentrations precludes the formation of a homogeneous liquid crystal phase throughout the material as not enough surfactant is present for this purpose. Rather, the above methods rely on the surfactant-precursor interactions discussed above to form liquid crystalline phases in areas of the synthesis mixture where templating occurs.

The present invention describes a mesoporous material characterised by a relatively disordered pore structure, such that strong peaks are not observed in small angle x-ray scattering analysis in the region where mesopore ordering is normally observed. Further, the synthetic method used to fabricate the mesoporous materials of the present invention differs substantially from those discussed above in that the methods of the present invention do not rely on surfactant-precursor interactions in order to form the liquid crystal template. Rather, the method of the present invention uses surfactant concentrations high enough (generally greater than 25%) to form an homogeneous liquid crystal phase that is formed without relying on interactions with the precursor species.

U.S. Pat. No. 6,558,847 describes the use of mesoporous materials with well ordered pore structures as electrode materials in lithium ion batteries. These materials are formed using synthetic pathways relying on low surfactant concentrations and surfactant-precursor interactions as discussed above. Thus, the present invention differs from the invention claimed in this document by virtue of the lower degree of mesopore structural ordering in the present invention and the method of synthesis in that the reaction mixture does not consist in an homogeneous liquid crystal phase in the cited art.

Shi and co-authors in Electrochemical and Solid State Letters, vol. 8(8), p. A396, 2005 describe a mesoporous form of iron phosphate (FePO4) for use in lithium ion batteries made using a surfactant templating approach. Materials with pore size distributions characterised by peak half-height widths of between approximately 10 nm and 20 nm were described however the surface area of these materials reached a maximum of only 54 m²/g, indicating that the mesopore network may not run continuously throughout the bulk of the material. These materials had peak half-height width to peak position ratios of 0.8 and 1.25, reflecting the relatively high degree of mesopore disorder. Jiao and Bruce in Advanced Materials vol. 19, p. 657, 2007 describe a mesoporous form of manganese dioxide (MnO2) for use in lithium ion batteries. The materials described have a high surface area of 127 m²/g and very well ordered mesopore structures characterised by a narrow pore size distribution with a peak half height of only approximately 1.2 nm and a peak half-height width to position ratio of approximately 0.32.

In the accompanying drawings:

FIG. 1 shows an exemplary plot of pore volume against pore diameter to illustrate the calculation of the disorder ratio;

FIG. 2 shows the pore size distribution determined by nitrogen desorption of the products of Example 1;

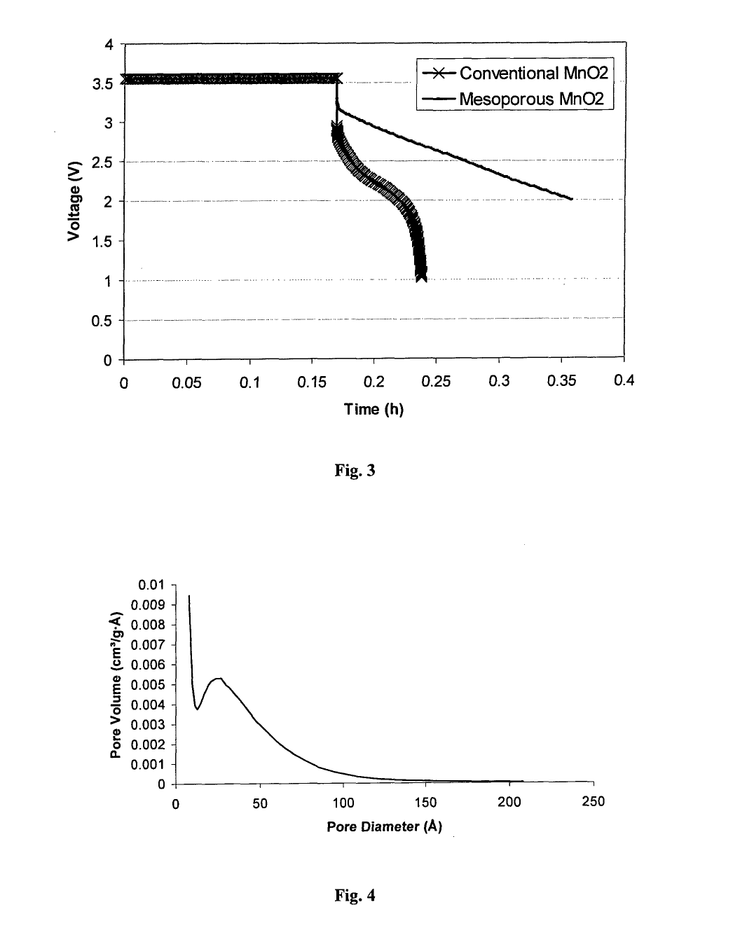

FIG. 3 shows discharge curves for the cells prepared as described in Examples 3 and 5.

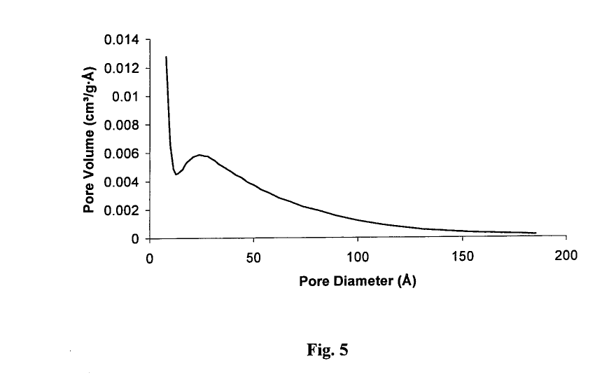

FIG. 4 shows the pore size distribution determined by nitrogen desorption of the product of Example 7; and

FIG. 5 shows the pore size distribution determined by nitrogen desorption of the products of Example 8.

There is no limitation on the nature of the elements or compounds of which the particulate material of the present invention is composed, provided that it is capable of being prepared using liquid crystal templating. Examples of such elements and compounds include:

1. Metals, such as magnesium, nickel, platinum, cobalt, iron, tin, lead, bismuth, beryllium, selenium, manganese, aluminium, ruthenium, chromium, copper, zinc, niobium, molybdenum, ruthenium, titanium, palladium, gold, silver, cadmium, tantalum, tungsten, mercury, rhodium and iridium, or mixtures or alloys of any two or more thereof, more preferably manganese, nickel or cobalt or a mixture or alloy thereof, especially manganese or nickel and mixtures of nickel with other metals, e.g. nickel/cobalt;
2. Alloys of metals or metalloids containing gallium or germanium;
3. Oxides of metals or metalloids, such as beryllium oxide BeO, magnesium oxide MgO, calcium oxide CaO, strontium oxide SrO, barium oxide BaO, scandium oxide Sc₂O₃, titanium oxide TiO, titanium dioxide TiO₂, titanium(III) oxide Ti₂O₃, titanium oxide (Ti₅O₁₂), vanadium oxide VO, vanadium dioxide VO₂, vanadium pentoxide V₂O₅, chromium(ILIII) oxide Cr₃O₄, chromium dioxide CrO₂, manganese oxide MnO, manganese(ILIII) oxide Mn₃O₄, manganese dioxide MnO₂, manganese(VIII) oxide Mn₂O₇, iron oxide FeO, iron(II,III) oxide Fe₂O₃, cobalt oxide CoO, cobalt(II,III) oxide Co₂O₃, nickel oxide NiO, nickel(III) oxide Ni₂O₃, nickel (IV) oxide (NiO₂), copper(I) oxide Cu₂O, copper(II) oxide CuO, zinc oxide ZnO, yttrium oxide Y₂O₃, zirconium oxide ZrO₂, niobium oxide NbO, niobium dioxide NbO₂, niobium(V) oxide Nb₂O₅, molybdenum(III) oxide Mo₂O₃, molybdenum(IV) dioxide MoO₂, molybdenum(VI) oxide MoO₃, ruthenium dioxide RuO₂, ruthenium(VIII) oxide RuO₄, rhodium oxide Rh₂O₃, palladium oxide PdO, silver oxide Ag₂O, silver(II) oxide AgO, cadmium oxide CdO, lanthanum oxide La₂O₃, hafnium oxide HfO₂, tantalum oxide(IV) oxide TaO₂, tantalum(V) oxide Ta₂O₅, tungsten oxide WO₂, tungsten(VI) oxide W0₃, rhenium(IV) oxide ReO₂, rhenium(V) oxide Re₂O₅, rhenium(VI) oxide Re0₃, osmium(II) oxide OsO₂, osmium(VIII) oxide OsO₄, iridium oxide(III) Ir₂O₃, iridium dioxide IrO₂, platinum oxide PtO, platinum dioxide PtO₂, aluminium oxide Al₂O₃, gallium oxide Ga₂O₃, indium oxide In₂O₃, thallium(I) oxide Tl₂O, thallium(III) oxide Tl₂O₃, silicon dioxide SiO₂, germanium(II) oxide GeO, germanium(IV) oxide GeO₂, tin(II) oxide SnO, tin(IV) oxide SnO₂, lead(II) oxide PbO, lead(II,III) oxide Pb₂O₃, lead(IV) oxide PbO₂, bismuth oxide Bi₂O₃, cerium(III) oxide Ce₂O₃, cerium(IV) oxide CeO_{2,} nickel-manganese oxides, nickel-cobalt-aluminium oxides,
4. Metal hydroxides, for example transition metal hydroxides, such as nickel hydroxide Ni(OH)₂, cobalt (II) hydroxide Co(OH)₂, yttrium (III) hydroxide Y(OH)₃, zirconium (IV) hydroxide Zr(OH)₄, scandium (III) hydroxide Sc(OH)₃, copper (II) hydroxide Cu(OH)₂, zinc (II) hydroxide Zn(II)₂, chromium (H) hydroxide Cr(OH)₂, chromium (III) hydroxide Cr(OH)₃, iron (II) hydroxide Fe(OH)₂, iron (III) hydroxide Fe(OH)₃, cadmium (II) hydroxide Cd(OH)₂, silver (II) hydroxide Ag(OH)₂ and niobium(II) hydroxide Nb(OH)₂. Lanthanide and actinide hydroxides such as cerium (IV) hydroxide Ce(OH)₄, lanthanum (III) hydroxide La(OH)₃, praseodymium (III) hydroxide Pr(OH)₃, neodymium (III) hydroxide Nd(OH)₃, samarium(III) hydroxide Sm(OH)₃, europium (III) hydroxide Eu(OH)₃, gadolinium (III) hydroxide Gd(OH)₃, terbium (III) hydroxide Tb(OH)₃, dysprosium (III) hydroxide Dy(OH)₃, holmium (III) hydroxide Ho(OH)₃, erbium (III) hydroxide Er(OH)₃; and Group 13 and 14 hydroxides, such as aluminium hydroxide Al(OH)₃ and tin(II) hydroxide Sn(OH)₂;
5. Metal oxy-hydroxides, for example transition metal oxyhydroxides, such as cobalt oxyhydroxide CoOOH, manganese oxyhydroxide, iron (III) oxyhydroxide, nickel (III) oxyhydroxide, cobalt (III) oxyhydroxide, titanium (IV) oxyhydroxide TiO(OH)₂, chromium (III) oxyhydroxide. Tantalum (VI) oxyhydroxide TaO(OH)₃ tungsten (IV) oxyhydroxide WO(OH)₂ niobium oxyhydroxide and scandium (III) oxyhydroxide; and Group 13 and 14 oxyhydroxides, such as tin oxyhydroxide Sn₃O₂(OH)₂ and aluminium oxyhydroxide AlOOH;
6. Lithiated forms of metal oxides, hydroxides and oxy-hydroxides, such as the lithiated forms of manganese dioxide (LiₓMnO₂), cobalt oxide (LiₓCoO₂), manganese oxide (LiₓMn₂O₄), nickel-manganese oxides (such as Li_{y}NiₓMn₂₋ₓO₄), nickel-manganese-cobalt oxides (such as LiₓNi_{y}Mn_{z}Co_{w}O₂), nickel-cobalt-aluminium oxides (such as LiₓNi_{y}Co_{z}Al_{w}O₂), titanium oxides (such as Li₄Ti₅O₁₂);
7. Mixed metal oxides, for example: aluminates, such as barium aluminate BaAl₂O₄, beryllium aluminate BeAl₂O₄, calcium aluminate CaAl₂O₄, cobalt aluminate CoAl₂O₄, iron (II) aluminate FeAl₂O₄, magnesium aluminate MgAl₂O₄; zinc aluminate ZnAl₂O₄; chromates, such as barium chromate(VI) BaCrO₄: molybdates, such as cadmium molybdate CdMoO₄, calcium molybdate CaMoO₄, cobalt molybdate CoMoO₄, iron (II) molybdate FeMoO₄, thallium (I) molybdate Ti₂MoO₄, zinc molybdate ZnMoO₄; stannates, such as barium stannate BaSnO₃, bismuth stannate Bi₂(SnO₃)₃.5H₂O, cobalt stannate Co₂SnO₄; titanates, such as barium titanate BaTiO₃, bismuth titanate Bi₄(TiO₄)₃; tungstates, such as barium tungstate BaWO₄, calcium tungstate CaWO₄, cadmium tungstate CdWO₄, cobalt tungstate CoWO₄, copper (II) tungstate CuWO₄, copper (II) tungstate dihydrate CuWO₄.2H₂O, iron (II) tungstate FeWO₄, lead (II) tungstate PbWO₄, magnesium tungstate MgWO₄, manganese (II) tungstate MnWO₄, potassium tungstate K₂WO₄; vanadates, such as bismuth vanadate BiVO₄, barium orthovanadate Ba₃(VO₄)₂, iron (III) metavanadate Fe(VO₃)₃, lead (II) metavanadate Pb(VO₃)₃. zirconates, such as barium zirconate BaZrO₃, calcium zirconate CaZrO₃, lead (II) zirconate PbZrO₃; barium copper yttrium oxides (BaCuY₂O₅, Ba₂Cu₃YO₇, Ba₂Cu₃YO₇, Ba₄Cu₇Y₂O₁₅); other examples, such as lead antimonite Pb₃(SbO₄)₂, lithium niobate LiNbO₃, lithium tantalite LiTaO₃, potassium niobate KNbO₃, sodium niobate NaNbO₃, yttrium aluminium oxide Y₂Al₅O₁₂ and aluminium silicates Al₂SiO₃(OH)₄.
8. Phosphates, for example: transition metal phosphates, such as scandium phosphate, titanium(II) phosphate Ti₃(PO₄)₂, titanium(III) phosphate TiPO₄, vanadium(II) phosphate V₃(PO₄)₂, vanadium(III) phosphate VPO₄, chromium(III) phosphate Cr(III)PO₄, manganese(II) phosphate Mn₃(PO₄)₂, manganese(III) phosphate MnPO₄, iron(II) phosphate Fe₃(PO₄)₂, iron(III) phosphate FePO₄, cobalt(II) phosphate Co₃(PO₄)₂, cobalt(III) phosphate CoPO₄, nickel(II) phosphate Ni₃(PO₄)₂, nickel(III) phosphate NiPO₄, copper(II) phosphate Cu₃(PO₄)₃, zinc phosphate Zn₃(PO₄)₂, zinc pyrophosphate Zn₂P₂O₇; group 13 and 14 phosphates, such as aluminium phosphate AlPO₄, tin(IV) phosphate SnPO₄, tin phosphate SnOP₂O₅, lead(II) phosphate Pb₃(PO₄)₂; lanthanide and actinide phosphates such as lanthanum phosphate La₃(PO₄)₂, cerium phosphate Ce₃(PO₄)₂.
9. Lithiated metal phosphates, such as lithiated iron phosphate LiFePO₄, lithiated manganese phosphate;
10. Phosphides, for example: transition metal phosphides, such as titanium phosphide TiP, zinc phosphide Zn₃P₂ and copper phosphide Cu₃P; group 13 and 14 phosphides, such as indium phosphide InP, tin phosphide SnP and thallium phosphide TIP, also phosphides containing a mixture of zinc, cadmium, indium and germanium.
11. Sulphates, for example: group 2 sulphates, such as magnesium sulphate MgSO₄ and CaSO₄; transition metal sulphates, such as vanadium(II) sulphate VSO₄ and zinc(II) sulphate; group 13 and 14 sulphates such as tin sulphate SnSO₄.
12. Sulphides, for example: transition metal sulphides, such as cadmium sulphide CdS, silver sulphide Ag₂S, molybdenum sulphide MoS₂ and zinc sulphide ZnS; group 13 and 14 sulphides, such as indium sulphide In₂S₃ and lead sulphide PbS.
13. Nitrides, such as boron nitride BN, gallium nitride GaN, titanium nitride TiN, iron nitride Fe₂N and lithium nitride Li₃N.
14. Selenides, such as cadmium selenide CdSe, lead selenide PbSe, indium(III) selenide In₂Se₃ and copper indium gallium selenide CuInGaSe₂.
15. Tellurides, such as lead telluride, PbTe and cadmium telluride CdTe.
16. Metal acetates, such as aluminium acetate Al(OH)(C₂H₃O₂);
17. Metal borates, such as aluminium borate 2Al₂O₃.B₂O₃;
13. Metal nitrates;
17. Metal carbonates;
18. Metal carbides.

However, it should be emphasised that the present invention is applicable to any material capable of being deposited into a liquid crystal templating system.

Many of the above materials, especially the metals (such as nickel, platinum, cobalt, iron, tin, lead, selenium, manganese, aluminium, ruthenium, chromium, copper, zinc, niobium, molybdenum, titanium, palladium, gold, silver, cadmium, mercury, rhodium and iridium, or mixtures or alloys of any two or more thereof, more preferably nickel or cobalt or a mixture or alloy thereof), and the metal oxides, hydroxides, oxhydroxides and phosphates and lithiated forms thereof [such as nickel oxide, nickel hydroxide, nickel oxy-hydroxide, manganese dioxide (MnO₂) and its lithiated form (LiₓMnO₂), cobalt oxide and its lithiated form (Li,CoO₂), manganese oxide and its lithiated form (LiₓMn₂O₄), nickel-manganese oxides and their lithiated forms (such as Li_{y}NiₓMn₂₋ₓO₄), nickel-manganese-cobalt oxides and their lithiated forms (such as LiₓNi_{y}Mn_{z}Co_{w}O₂), nickel-cobalt-aluminium oxides and their lithiated forms (such as LiₓNi_{y}Co_{z}Al_{w}O₂), titanium oxides and their lithiated forms (such as Li₄Ti₅O₁₂); metal phosphates such as iron phosphate and its lithiated forms (such as LiFePO₄) and manganese phosphate and its lithiated forms (such as LiMnPO₄)] are useful for the manufacture of electrodes for electrochemical cells.

Other compounds, such as platinum, palladium, rhodium and iridium and their compounds, especially their oxides, are used as catalysts, and these elements and compounds, when prepared according to the present invention, have the same advantages of high surface area and ease of access to that surface area as do the prior art materials having ordered arrays of pores.

Silica and cerium oxide are very commonly used as supports for other active materials which lack their structural integrity, for example as a support for catalytic materials, and, when prepared in accordance with the present invention, have the same advantages of high surface area and ease of access to that surface area as do the prior art materials having ordered arrays of pores.

As illustrated, for example, in EP 0993512 (U.S. Pat. No. 6,503,382), EP963266 (U.S. Pat. No. 6,203,925), EP 1570534, EP 1570535, and EP 1741153, the disclosures of which are expressly incorporated herein by reference, the desired materials may be prepared by a variety of methods, provided that they are compatible with liquid crystal technology, principally by chemical or electrochemical deposition. The exact method chosen will depend on the nature of the material being prepared and the nature of the material (the “precursor material”) from which it is prepared, as is well known in the art, and illustrated in the patents cited above. For example, the precursor compounds employed to prepare a mesoporous metal are preferably metal salts. The salts used will, of course, depend on the metal or compound of the metal to be deposited and should be soluble in the solvent employed. Examples of such salts include the chlorides, acetates, sulphates, bromides, nitrates, sulphamates, and tetrafluoroborates, especially those of the above metals, and, for example for the preparation of nickel, preferably nickel (II) chloride, nickel (II) acetate, nickel (II) sulphate, nickel (II) bromide, nickel (II) nitrate, nickel (II) sulphamate, and nickel (II) tetrafluoroborate.

Depending on the reaction conditions, the metal or semi-metal itself may be deposited or a compound of the metal or semi-metal may be deposited. Examples of such compounds of metals and semi-metals include the oxides and hydroxides.

In general, the reaction mixture will comprise at least: a precursor material; a solvent; and an organic structure-directing agent, generally a surfactant, in amounts sufficient to form a liquid crystal phase in the mixture. In cases where it is required to facilitate reaction of the precursor material to form the desired deposited material, another material may be added to the mixture in order to facilitate deposition. In the case of deposition of metals from metal salts this may be a reducing agent. In the case of deposition of a metal hydroxide from a metal salt precursor this may be an agent such as an alkali-metal hydroxide that increases the pH of the mixture in order to cause precipitation of the metal hydroxide product.

In accordance with the present invention, we have found that, where the precursor material is present in the aqueous component of the reaction mixture in relatively high concentrations, higher than has hitherto been used, a relatively disordered material in accordance with the present invention is produced. In general, the concentration of the precursor material in the appropriate component of the liquid crystal system should be as high as possible in order to maximise the yield of material from the mixture but while still maintaining the liquid crystalline phase required for templating. The maximum permissible concentration required to achieve this is dependent on the type of surfactant used, the type of precursor material used and the surfactant-solvent ratio. As such, the maximum permissible precursor concentration varies considerably from mixture to mixture.

The mixture of solvent, surfactant and precursor material, optionally with other components such as are well known in the art, will form a liquid crystal phase. The desired element or compound is then deposited from the mixture using conventional chemical or electrochemical means. Since mesostructured materials often lack structural strength, they may be deposited onto a substrate, e.g. a metal, such as gold, copper, silver, platinum, tin, aluminium, nickel, rhodium or cobalt, an alloy containing any of these metals or another high surface area support. The substrate may, if desired, be macroporous, with pores of a size preferably in the range from 20 to 500 micrometres. Where the substrate is a metal foil, the substrate preferably has a thickness in the range from 2 to 50 micrometres.

Suitable methods for depositing mesoporous materials as films onto a substrate by chemical or electrochemical deposition are known in the art. For example, suitable electrochemical deposition methods are disclosed in EP-A-993,512; Nelson, et al., “Mesoporous Nickel/Nickel Oxide Electrodes for High Power Applications”, J. New Mat. Electrochem. Systems, 5, 63-65 (2002); Nelson, et al., “Mesoporous Nickel/Nickel Oxide—a Nanoarchitectured Electrode”, Chem. Mater., 2002, 14, 524-529.

Preferably, the mesoporous material is formed by chemical or electrochemical deposition from a lyotropic liquid crystalline phase. According to a general method, a template is formed by self-assembly from the long-chain surfactants described above and water into a desired liquid crystal phase. The mesoporous structure has an arrangement of pores having a high surface area with much of this surface area being derived form pores with diameters in the range 2 nm to 20 nm. However, while this pore structure may run continuously throughout the volume of the material it may lack a defined, recognisable topology or architecture, consistent with for example cubic, lamellar, oblique, centred rectangular, body-centred orthorhombic, body-centred tetragonal, rhombohedral or hexagonal mesopore structures as described in earlier work as cited above.

In the mesoporous materials of the present invention, where the material is a metal, it has a surface area of 30 m²/g or greater, preferably from 30 m²/g to 150 m²/g, more preferably from 30 m²/g to 95 m²/g. Since metals are, in general significantly denser than non-metals, in the case of materials other than metals, it should have a surface area of 100 m²/g or greater, preferably from 100 to 900 m²/g, more preferably from 200 m²/g to 600 m²/g.

The relatively high precursor concentration in the liquid crystal maximises the amount of product produced per unit mass of surfactant and hence decreases the cost of the surfactant used in the process by allowing less to be used. These high concentrations also reduce reaction time, and we have found that increasing the rate of the reaction to form the mesoporous material in the liquid crystal reduces processing cost by reducing cycle time on associated equipment.

The organic structure-directing agent is included in the mixture in order to impart an homogeneous lyotropic liquid crystalline phase to the mixture. The liquid crystalline phase is thought to function as a structure-directing medium or template for deposition of the mesoporous material. By controlling the nanostructure of the lyotropic liquid crystalline phase, mesoporous material may be synthesised having a corresponding nanostructure. For example, porous materials formed from normal topology hexagonal phases will have a system of pores disposed on an hexagonal lattice, whereas porous materials formed from normal topology cubic phases will have a system of pores disposed in cubic topology. Similarly, porous materials having a lamellar nanostructure may be deposited from lamellar phases. In the case of the present invention, however, the deposition of material is carried out relatively rapidly which may result in disruption of the structure of the liquid crystal phase as material is rapidly deposited around the molecules of the ‘soft’ template. As a result, materials with more disordered porosity may result.

Any suitable amphiphilic organic compound or compounds capable of forming a homogeneous lyotropic liquid crystalline phase may be used as structure-directing agent, either low molar mass or polymeric. These may include compounds sometimes referred to as organic directing agents. In order to provide the necessary homogeneous liquid crystalline phase, the amphiphilic compound will generally be used at a high concentration, typically at least 25% by weight, and more preferably at least 30% by weight, based on the total weight of the solvent, source material and amphiphilic compound.

For example, the organic structure-directing agent may comprise an organic surfactant compound of the formula RQ wherein R represents a linear or branched alkyl, aryl, aralkyl or alkylaryl group having from 6 to about 60 carbon atoms, preferably from 12 to 18 carbon atoms, and Q represents a group selected from: [O(CH₂)ₘ]ₙOH wherein m is an integer from 1 to about 4 and preferably m is 2, and n is an integer from 2 to about 60, preferably from 4 to 12; nitrogen bonded to at least one group selected from alkyl having at least 4 carbon atoms, aryl, aralkyl and alkylaryl; and phosphorus or sulphur bonded to at least 2 oxygen atoms. Other suitable structure-directing agents include monoglycerides, phospholipids and glycolipids.

Other suitable compounds include surface-active organic compounds of the formula R₁R₂Q wherein R₁ and R₂ represent aryl or alkyl groups having from 6 to about 36 carbon atoms or combinations thereof, and Q represents a group selected from:—(OC₂H₄)ₙOH, wherein n is an integer from about 2 to about 20; nitrogen bonded to at least two groups selected from alkyl having at least 4 carbon atoms, and aryl; and phosphorus or sulphur bonded to at least 4 oxygen atoms.

Preferably non-ionic surfactants such as octaethylene glycol monododecyl ether (C₁₂EO₈ , wherein EO represents ethylene oxide) and octaethylene glycol monohexadecyl ether (C₁₆EO₈) or commercial products containing mixtures of related molecules are used as organic structure-directing agents. Other preferred organic directing agents include polyoxyalkylene derivatives of propylene glycol, such as the tri-block copolymers sold under the trade mark “Pluronic”, ionic surfactants such as CTAB and di-block copolymers such as those based on blocks of polyethylene oxide (PEO) and polybutylene oxide (PBO).

Ionic surfactants capable of forming a liquid crystal phase in the mixture of the present invention may also be used. Preferred such surfactants are those having an ionic group attached, directly or indirectly, to one or more hydrocarbon chains having at least 8 carbon atoms, preferably from 8 to 30 carbon atoms. By “ionic group” we mean a group, such as an ammonium group, which already contains ions, or a group, such as an amine group, which can readily form ions. Examples of such compounds include amines and ammonium compounds e.g. of formula NR¹R²R³ or N⁺R¹R²R³R⁴ X⁻, where at least one of R¹, R² and R³ or R¹, R², R³ and R⁴ represents a hydrocarbon group having at least 8, preferably at least 10, more preferably from 8 to 30 and most preferably from 10 to 20, carbon atoms, and X⁻represents an anion. Other examples include salts containing long chain fatty acid or hydrocarbon residues, said residues each having at least 8, preferably at least 10, more preferably from 8 to 30 and most preferably from 10 to 20, carbon atoms. Specific examples of preferred surfactants include cetyltrimethylammonium chloride (CTAC), cetyltrimethylammonium bromide (CTAB), sodium dodecyl sulphate (SDS), hexadecyl amine (HDA), dodecyltrimethylammonium chloride (DTAC) and dioctyl sodium sulphosuccinate (also known as Aerosol OT—AOT). AOT and SDS are anionic surfactants while the others specified by the formulae NR¹R²R³ or N⁺R¹R²R³R⁴ X⁻are cationic. Of these, the preferred surfactants are the ammonium compounds, especially cetyltrimethylammonium bromide.

It has been found that the pore size of the porous material can be varied by altering the hydrocarbon chain length of the surfactant used as structure-directing agent, or by supplementing the surfactant by an hydrocarbon additive. For example, shorter-chain surfactants will tend to direct the formation of smaller-sized pores whereas longer-chain surfactants tend to give rise to larger-sized pores. The addition of a hydrophobic hydrocarbon additive such as n-heptane, to supplement the surfactant used as structure-directing agent, will tend to increase the pore size, relative to the pore size achieved by that surfactant in the absence of the additive. Also, the hydrocarbon additive may be used to alter the phase structure of the liquid crystalline phase in order to control the corresponding regular structure of the porous material. By a suitable combination of these methods, it is possible to control the pore size very precisely and over a wide range, extending to much smaller pore sizes (of the order of 1 nm) than could be achieved hitherto.

The solvent is included in the mixture in order to dissolve the source material and to form a liquid crystalline phase in conjunction with the organic structure-directing agent, thereby to provide a medium for deposition of the mesoporous material. Generally, water will be used as the preferred solvent. However, in certain cases it may be desirable or necessary to carry out the deposition in a non-aqueous environment. In these circumstances a suitable organic solvent may be used, for example formamide or ethylene glycol.

In most cases, the source material will dissolve in the solvent domains of the liquid crystalline phase, but in certain cases the source material may be such that it will dissolve in the hydrophobic domains of the phase.

The mesoporous particulate particles of the present invention are particularly useful as electrode materials, especially in electrodes for batteries and capacitors.

The invention is further illustrated by the following non-limiting Examples.

### EXAMPLE 1

### Mesoporous MnO₂ templated from Pluronic F127 with TEGMME

88.0 ml of a 0.25 M sodium permanganate solution (aqueous) was added to 71.5 g of Pluronic F127 surfactant. The mixture was stirred vigorously until a homogeneous liquid crystal phase was formed, and then 3.43 ml of triethylene glycol monomethyl ether (TEGMME) was added and stirred through the mixture. The reaction vessel was sealed and then left for 3 hours in a 90° C. oven to react. The surfactant was removed from the resultant product via repeated washing in deionised water. The collected powder was dried at 60° C. for 2 days.

The mesoporous MnO₂ as made had a surface area of 265 m²/g and a pore volume of 0.558 cm³/g as determined by nitrogen desorption. The pore size distribution also determined by nitrogen desorption is shown in FIG. 2 of the accompanying drawings. This shows a large pore size variance with a peak in the distribution at approximately 110 Angstroms with a value of 0.0034 cm³/g.Å and a peak half height width of approximately 16 nm. A peak half-height width to peak position ratio of 1.45 is observed for the material.

### Acid Treatment

2.0 g of the as made mesoporous MnO₂ was then added to 20 ml of 3.0 M nitric acid solution in a conical flask. A condenser was attached, and the solution was heated to 90° C. while stirring, after which it was held for 30 minutes. The solid was then filtered off and washed with deionised water. The powder was then dried overnight at 60° C. to remove most of the water.

The mesoporous MnO₂ after this acid treatment had a surface area of 252 m²/g and a pore volume of 0.562 cm³/g as determined by nitrogen desorption. The pore size distribution also determined by nitrogen desorption is shown in FIG. 2 of the accompanying drawings. This shows a large pore size variance with a peak in the distribution at approximately 115 Angstroms with a value of 0.0034 cm³/g.Å and a peak half height width of approximately 16 nm. A peak half-height width to peak position ratio of 1.39 is observed for the material.

### Heat Treatment

After the above acid treatment the mesoporous MnO₂ powder was placed in a ceramic crucible and heated to 350° C. in a chamber furnace at a ramp rate of 1.0° C/minute under air. The furnace was then turned off and allowed to cool down overnight before the sample was removed.

The mesoporous MnO₂ after this heat treatment had a surface area of 178 m²/g and a pore volume of 0.569 cm³/g as determined by nitrogen desorption. The pore size distribution also determined by nitrogen desorption is shown in FIG. 2 of the accompanying drawings. This shows a large pore size variance with a peak in the distribution at approximately 160 Angstroms with a value of 0.0041 cm³/g.Å and a peak half height width of approximately 12 nm. A peak half-height width to peak position ratio of 0.75 is observed for the material.

### EXAMPLE 2

### Preparation of Mesoporous MnO₂ Electrode

1.0 g of mesoporous MnO₂ powder was added to 0.056 g of carbon (Vulcan XC72R) and mixed by hand with a pestle and mortar for 5 minutes. Then 0.093 g of PTFE-solution (polytetrafluoroethylene suspension in water, 60 wt. % solids) was added to the mixture and mixed for a further 5 minutes with the pestle and mortar until a thick homogenous paste was formed.

The composite paste was fed through a rolling mill to produce a free standing film. Discs were then cut from the composite film using a 12.5 mm diameter die press and dried under vacuum at 120° C. for 24 hours. This resulted in a final dry composition of 90 wt. % MnO₂, 5 wt. % carbon and 5 wt. % PTFE.

### EXAMPLE 3

### Preparation of a Mesoporous MnO₂ based Electrochemical Cell

An electrochemical cell was assembled in an Argon containing glove-box. The cell was constructed using an in-house designed sealed electrochemical cell holder. The mesoporous MnO₂ disc electrode produced in Example 4 was placed on an aluminium current collector disc and two glass fibre separators were placed on top. Then 0.5 mL of electrolyte (0.75 M lithium perchlorate in a three solvent equal mix of propylene carbonate, tetrahydrofuran and dimethoxyethane) was added to the separators. Excess electrolyte was removed with a pipette. A 12.5 mm diameter disc of 0.3 mm thick lithium metal foil was placed on the top of the wetted separator and the cell was sealed ready for testing.

### EXAMPLE 4

### Preparation of Conventional MnO₂ Electrode

The procedure of Example 2 was repeated but replacing the mesoporous MnO₂ with a conventional, commercially available MnO₂ powder (Mitsui TAD-1 Grade).

### EXAMPLE 5

### Preparation of a Conventional MnO₂ based Electrochemical Cell

The procedure of Example 3 was repeated but using the positive electrode fabricated using conventional MnO₂ as described in Example 4.

### EXAMPLE 6

### Testing of a MnO₂ based Electrochemical Cell

The discharge currents required for 1 C rate discharge of the electrochemical cells fabricated as described in Example 3 (mesoporous MnO₂) and Example 5 (conventional MnO₂) were calculated using a theoretical capacity of 308 mAh/g. The electrochemical cells were then discharge using these current values. The discharge curves for both cells are shown in FIG. 3 of the accompanying drawings.

### EXAMPLE 7

### Synthesis of Mesoporous Nickel Hydroxide

36 g of BCIO surfactant was added to a mixture containing 22.8 cm³ of 1.65 M nickel(II) chloride solution (aqueous) and 1.2 cm³ of 1.65 M cobalt(II) chloride solution (aqueous). The resulting paste was hand mixed until homogeneous. A second batch of 36 g of BC10 was added to 24 cm³ of 3.3 M sodium hydroxide solution (aqueous). The resulting paste was hand mixed until homogeneous.

The two mixtures were stirred together by hand until homogeneous and allowed to stand at room temperature overnight. The surfactant was removed from the resultant product via repeated washing in deionised water followed by a final wash in methanol solvent. The collected powder was dried overnight in an oven (48 hours) and then ground using a pestle and mortar.

The resulting powder had a BET surface area of 275 m² g⁻¹ and pore volume of 0.29 cm³ g⁻¹. The pore size distribution also determined by nitrogen desorption is shown in FIG. 4 of the accompanying drawings. This shows a large pore size variance with a peak in the distribution at approximately 2.69 nm with a value of 0.00529 cm³/g.Å and a peak half height width of approximately 4.1 nm. A peak half-height width to peak position ratio of 1.52 is observed for material.

### EXAMPLE 8

### Synthesis of Mesoporous Nickel Hydroxide (Alternative Version)

300 g of BC10 surfactant was added to a mixture containing 190 cm³ of 1.65 M nickel(II) chloride solution (aqueous) and 10 cm³ of 1.65 M cobalt(II) chloride solution (aqueous). The resulting paste was hand mixed until homogeneous. A second batch of 300 g of BC 10 was added to 200 cm³ of 3.3 M sodium hydroxide solution (aqueous). The resulting paste was hand mixed until homogeneous.

The two mixtures were stirred together using a ‘z-blade’ mixer until homogeneous and allowed to stand at room temperature overnight. The surfactant was removed from the resultant product via repeated washing in deionised water followed by a final wash in methanol solvent. The collected powder was dried overnight in an oven (48 hours) and then ground using a pestle and mortar.

The resulting powder had a BET surface area of 342 m² g⁻¹ and pore volume of 0.40 cm³ g⁻¹. The pore size distribution also determined by nitrogen desorption is shown in FIG. 5 of the accompanying drawings. This shows a large pore size variance with a peak in the distribution at approximately 2.35 nm with a value of 0.00587 cm³/g.Å and a peak half height width of approximately 4.8 nm. A peak half-height width to peak position ratio of 2.03 is observed for the material.

1. A mesoporous particulate material having internal porosity, a surface area, in the case of a metal, of at least 30 m²/g or, in other cases, of at least 100 m²/g with a network of pores characterised by a peak in the BJH pore size distribution in the range from 2 to 20 nm and a disorder ratio, as defined, of at least 0.6.

2. A material according to claim 1, which is a metal having a surface area of at least 30 m²/g.

3. A material according to claim 2, having a surface area of from 30 m²/g to 150 m²/g.

4. A material according to claim 3, having a surface area of from 30 m²/g to 95 m²/g.

5. A material according to claim 1, which is not a metal and has a surface area of at least 100 m²/g.

6. A material according to claim 5, having a surface area of from 100 m²/g to 900 m²/g.

7. A material according to claim 6, having a surface area of from 200 m²/g to 600 m²/g.

8. A material according to claim 2, in which the metal is selected from the group consisting of magnesium, nickel, platinum, cobalt, iron, tin, lead, bismuth, beryllium, selenium, manganese, aluminium. ruthenium, chromium, copper, zinc, niobium, molybdenum, ruthenium, titanium, palladium, gold, silver, cadmium, tantalum, tungsten, mercury, rhodium and iridium, or mixtures or alloys of any two or more thereof

9. A material according to claim 8, in which said metal is manganese, nickel or cobalt or a mixture or alloy thereof.

10. A material according to claim 5, which is an oxide, hydroxide or oxy-hydroxide of a metal.

11. A material according to claim 10, which is manganese dioxide, nickel oxide, nickel oxy-hydroxide or nickel hydroxide.

12. A material according to claim 5, which is silica.

13. A material according to claim 1, in which the disorder ratio is from 0.6 to 12.

14. A material according to claim 13, in which the disorder ratio is from 0.6 to 5.

15. A material according to claim 14, in which the disorder ratio is from 0.7 to 3.

16. A material according to claim 1, which is suitable for use as an electrode.

17. A method for the manufacture of an electrochemical cell, said method comprising employing particulate material according to claim 1 for the manufacture thereof.

18. A method according to claim 17, wherein the electrochemical cell is for use in a battery or capacitor.

19. An electrode comprising a mesoporous particulate material according to claim 1.

20. An electrode according to claim 19 for use in a capacitor or battery.

21. An electrochemical cell having at least one electrode according to claim 19.

22. A battery comprising an electrochemical cell according to claim 21.

23. A capacitor comprising an electrochemical cell according to claim 21.

24. A process for the preparation of a mesoporous particulate material formed of a first compound or an element, which process comprises:
forming a mixture comprising a second compound from which the first compound or element may be deposited, a solvent and a surfactant in amounts sufficient to form a liquid crystal phase in the mixture; and
depositing the first compound or the element from the second compound, under conditions of concentration, reaction time and reaction temperature such as to form a mesoporous particulate material
wherein the resulting particles have internal porosity characterised by a disordered pore structure, a surface area, in the case of a metal, of at least 30 m²/g or, in other cases, of at least. 100 m²/g with a network of pores characterised by a peak in the pore size distribution between 2 and 20 nm and a disorder ratio of at least 0.6.

25.-34. (canceled)
